(19) United States
(12) Patent Application Publication
(10) Pub. No.: US 2024/0338590 A1
(43) Pub. Date: Oct. 10, 2024

(54) MID-CIRCUIT ERROR MITIGATION FOR QUANTUM OPTIMIZATION

(71) Applicant: Telefonaktiebolaget LM Ericsson (publ), Stockholm (SE)

(72) Inventors: Zoltán ZIMBORÁS, Budapest (HU); Zsófia KALLUS, Budapest (HU); Gábor NÉMETH, Budapest (HU); Péter HÁGA, Budapest (HU)

(73) Assignee: Telefonaktiebolaget LM Ericsson (publ), Stockholm (SE)

(21) Appl. No.: 18/577,628

(22) PCT Filed: Nov. 16, 2021
(86) PCT No.: PCT/SE2021/051144

§ 371 Date: Jan. 8, 2024

Related U.S. Application Data
(60) Provisional application No. 63/234,303, filed on Aug. 18, 2021.

(51) Int. Cl. G06N 10/60

(52) U.S. Cl. CPC G06N 10/60

(57) ABSTRACT

Methods, systems, and apparatuses for augmenting a quantum approximate optimization algorithm (QAOA) quantum circuit. Augmenting the quantum circuit may include adding to the quantum circuit one or more encoders (312) configured to perform unitary mapping of one-hot encoding basis states to basis states of a reduced number of qubits padded with one or more padding qubits in the zero computational basis state, mid-circuit measurements, and conditional resets. The mid-circuit measurements may be configured to cause one or more quantum processing units (QPUs) to measure one or more qubits of the augmented quantum circuit in the computational basis state. The one or more conditional resets may be configured to reset the augmented quantum circuit without full execution of a variational loop if one or more mid-circuit measurement results indicate that one or more qubits of the augmented quantum circuit are in an invalid state.

### TECHNICAL FIELD

The present disclosure relates generally to the technical field of quantum computing, and particularly to systems, apparatuses, and methods for mid-circuit error mitigation and filtering.

### BACKGROUND

Quantum computing is an interdisciplinary research area, with various small-scale processing units already available in full-stack systems for researchers and algorithm development. Access options range from on premise, local systems to cloud access schemes directly from quantum technology providers or using cloud providers (e.g., Amazon Braket or Azure Quantum with multiple backend options from quantum tech providers). Options range from system purchase through long-term co-design partnerships with remote access to flexible cloud platform pricing schemes and academic partnerships programs.

Variational circuits iterate towards optimal parameter settings with proven convergence leveraging a noisy quantum device and classical computation within a hybrid optimization loop. The area is a rapidly evolving research direction with multiple applications mapped to a few types of general quantum optimization techniques.

A prominent example is the Quantum Approximate Optimization Algorithm (QAOA), where there is proven convergence to an optimum for the general class of Quadratic Unconstrained Binary Optimization (QUBO) and Polynomial Unconstrained Binary Optimization (PUBO) problems mapped to quantum circuits. Research and development on this topic is further motivated by the many examples of combinatorial optimization problems in industry and science including, for example, scheduling, network traffic routing, and portfolio optimization. Finding a set of approximately optimal solutions is challenging for classical hardware, as the number of possible solutions scales exponentially, and problem specific heuristics are used for approximate solutions.

### SUMMARY

Certain challenges presently exist with respect to existing solutions for quantum computing. For example, currently available devices are noisy and of small scale, where 53 qubits presented the first proven quantum advantage via purpose-designed test without real-world application. More sophisticated algorithms require large-scale, error-corrected Quantum Processing Units (QPUs), but production is still facing both theoretic and engineering challenges. State-of-the-art error-correction methods require around a thousand physical qubits to represent a single logical one via redundant information encoding. Current toolkits introduced Error Mitigation techniques instead, which use only classical post processing of measurement results using the circuit structure and known classical correlation of variable errors. Existing solutions do not include algorithm-specific noise reduction methods and/or efficient algorithm design.

Existing solutions may include one or more of the following challenges:
Although variational quantum optimization algorithms can leverage noisy quantum processing units with proven convergence, their iterative runs of hybrid quantum-classical computation cycle need to be optimized for (i) reduced cost of runs and (ii) improved quality of the optimum returned.
Existing error mitigation and noise filtering methods are end-circuit operations (e.g., classical post-processing methods that can only reduce noise in the results of a fully executed circuit). This might reduce uncertainty, but the cost of the runs remains high.
Mid-circuit measurements are used only for efficient circuit design to reduce the number of qubits needed via qubit resetting conditional on mid-circuit measurement result. This is useful neither for circuit depth optimization nor for noise reduction.
Variational optimization algorithms relying on one-hot encoding of variables are known but need further error mitigation and/or filtering to leverage the valid latent subspace of the problem represented only by a subset of the circuit qubits.
Space-efficient encoding for reduction in circuit width is known for a set of one-hot encoding variational optimizers, but these algorithms can only use post-processing error mitigation. This method also has disadvantage of an increased depth of the circuit, which is the tradeoff for reduction in number of qubits.
For the Traveling Salesman problem, the problem-specific encoding change code lacks any generalization. The circuit augmentation is given as is, providing only a particular manual circuit design, decoupled from application details.
U.S. Patent Application Publication No. 2018/0260731 presents the Quantum Approximate Optimization Algorithm (QAOA) method with a hybrid classical quantum computing system. In this basic presentation of QAOA, there is no discussion about error detection and error mitigation.
U.S. Pat. No. 10,846,366 provides a system and method of parameter selection for QAOA algorithm depicted as a probabilistic optimization method where Bayesian Optimization is used to optimize parameters of QAOA for better sampling performance. In this basic presentation of QAOA, there is no discussion about error detection and error mitigation.
U.S. Pat. No. 11,023,638 focuses on cost reduction for the general variational quantum circuit optimization. In this patent, the important overall cost-reduction and accuracy problems are discussed without noise detection and reduction methods. Thus, the disclosed methods can be further improved by aspects of the error detection and mitigation by mid-circuit measurements described herein for the discussed special class of QAOAs.
Chinese Patent Application Publication No. CN111882068A provides a system and a noise reduction method specifically for QAOA solvers via introducing a performance index calculated for the entire QAOA circuit under different noise characteristics using preset noise model of the qubits and a preset noise model of the QAOA circuit. This method can only mitigate errors to a certain level and for a full circuit and requires a costly training process of the performance index under different noise intensities. It is, therefore, not leveraging aspects of the mid-circuit error detection and mitigation described herein for the special QAOA problem class. This error mitigation method is expected to underperform for the special class of QAOAs compared to aspects of the mid-circuit error detection and mitigation described herein.
International Patent Application Publication No. WO2020205618A1 gives a measurement-based optimization for general quantum circuits. The measurement-based optimization uses an active noise reduction method in which extra gates need to be inserted, with a classically-controlled correction phase using the result of the X basis measurement. It is, therefore, not leveraging aspects of the mid-circuit error detection and mitigation described herein in the special QAOA problem class. This error mitigation method is expected to underperform for the discussed special class of QAOAs compared to aspects of the mid-circuit error detection and mitigation described herein.

Aspects of the invention may address, for example and without limitation, a special class of Quantum Approximate Optimization Algorithm (QAOA) where one-hot encoding is feasible for the Quadratic Unconstrained Binary Optimization (QUBO) problem. In this case, there is the possibility of space-efficient encoding of the problem. Aspects of the invention may provide an error mitigation method applicable to at least this subclass, which includes general models such as, for example and without limitation, Clique Cover, Job Sequencing, Minimal Spanning Tree with MaximalDegree Constraint, Steiner Trees, Directed and Undirected Feedback Vertex Set, Graph Isomorphism, and Travelling Salesman problems. Many of these examples map to telecommunications-related problems as well.

The Traveling Salesman problem attempts to find the shortest possible route that visits each city in a list of cities exactly once and returns to the origin city (given the distances between each pair of cities in the list). For the Travelling Salesman problem, there exists a problem-specific encoding change code including mid-circuit filtering as only a fixed manual solution decoupled from use case details. However, aspects of the invention may provide generalization and automation for the overall QAOA subclass.

Aspects of the invention may leverage mid-circuit error detection and mitigation using a hardware capability of measuring qubit states in the middle of the circuit. Aspects of the invention may provide the option of resetting the qubit for further use (e.g., to achieve more compact circuits for small-scale QPUs). Aspects of the invention may provide mid-circuit (MC) error mitigation and filtering (EMF) as an automated extension for variational quantum optimization problems relying on one-hot encoded variables.

In some aspects, by leveraging the structure of such circuits, variables may be either projected back onto their valid latent space via mid-circuit measurements or, in case of destructive noise present in the circuit, altered. In some aspects, this may be achieved by performing projective measurement on the qubits serving as ancillas with expected 0 state results.

In some aspects, MC EMF may, without losing information, serve as a checkpoint for a decision to (a) continue the run as the solution has been forced back to its valid solution space in case of noisy circuit or (b) stop and restart, as the measurement showed a high distortion level at this run, and information leaked outside of the valid solution space caused by aggregated noise effects of imperfect hardware.

In some aspects, MC EMF may include post-processing of steps. In some aspects, MC EMF may include evaluating the result at the end of the circuit for filtering based on measured value of the ancilla qubits.

In some aspects, MC EMF may be implemented as an automated module in a full-stack quantum computing system. In some aspects, the output of the module may be an extended circuit, which may be communicated as a report toward the quantum algorithm developers and/or as a directly executable list of circuit commands toward the quantum compiler.

Aspects of the invention may provide a mid-circuit error mitigation method for variational quantum circuits. In some aspects, by using mid-circuit measurement, noisy valid states can be projected into their valid state. In some aspects, the error mitigation may significantly reduce the level of noise, may efficiently reduce the number of iterations needed for convergence of the optimization, and, hence, may reduce the overall cost.

In some aspects, by using mid-circuit measurements, distorted states may be projected outside of the valid latent space of the solution and may result in resetting the circuit within the given step of the optimization iteration loop, which may significantly reduce overall circuit evaluation cost.

In some aspects, the mid-circuit error mitigation method may use a priority list of the algorithm's variables to be considered first (e.g., in case of limited hardware capabilities for mid-circuit measurements).

Aspects of the invention may provide an automated circuit extension module. In some aspects, the automated circuit extension module may transform a simple QAOA algorithm input. In some aspects, the automated circuit extension module may efficiently mitigate errors via mid-circuit measurements using some parametrization for optional optimization aspects.

Aspects of the invention may provide a system to leverage the method of mid-circuit error mitigation. In some aspects, error mitigation via mid-circuit measurements may be integrated into a full-stack quantum computing architecture. In some aspects, the error mitigation via mid-circuit measurements may be integrated either as (a) an automation tool for extended algorithm creation for developers and/or (b) a background module for creation of extended circuits to be sent directly to lower layers of the stack (e.g., towards a compiler). In some aspects, the output of the error mitigation via mid-circuit measurements may serve as a report to algorithm developers of automated circuit design about the level of efficiency achieved and/or limiting factors of hardware and/or encodings. In some aspects, statistics of cost reduction via mid-circuit reset of distorted runs may additionally or alternatively be generated for the optimization process. In some aspects, the functionality may be used as a service and may be called dynamically for the same algorithm with different hardware backends accessed in quantum computing cloud platform environments.

Aspects of the invention may provide the advantage of noise reduction without the previous costs. In some aspects, error mitigation via mid-circuit measurements may be easily applied with encodings and circuit definitions for an extensive set of variational optimization algorithms relying on single or multiple one-hot encodings. In some aspects, error mitigation via mid-circuit measurements may achieve significant level of noise reduction on Near-Term Intermediate-Scale Quantum (NISQ) devices for one-hot encoded variational circuits.

Aspects of the invention may additionally or alternatively provide the advantage of improved overall algorithm performance without the previous tradeoffs. In some aspects, noise reduction may be achieved without extra qubits for error-correction-like redundant encoding methods and/or without an increase of logical circuit width. In some aspects, noise reduction may be achieved without asymptotical increase in circuit size as measured in the number of one- and two-qubit quantum gates, which may be contrary to, for example, in space-efficient embeddings. This will keep the overall error rate smaller. In some aspects, mid-circuit measurements for error filtering may reduce the number of costly gate operations by resetting the variational loop without full execution of runs distorted by errors. In some aspects, mid-circuit measurement for error mitigation may reduce the level of coherent noise in one-hot encodings. In some aspects, the reduction in the level of coherent noise may be similarly to the quantum Zeno effect. In some aspects, through the measurement, the noisy state may collapse to the correct one. In some aspects, mid-circuit measurements for error filtering may be applied to improve existing error mitigation methods introduced for full circuits.

Aspects of the invention may additionally or alternatively provide the advantage of integration and automation in NISQ and/or mid-term devices. In some aspects, automated application of mid-circuit error mitigation may hide these evaluations and provide noise reduction and more efficient optimization with reduced cost in the background. In some aspects, seamless integration of mid-circuit error mitigation in the quantum software stack may only require encoding and circuit definition, which may both be checked against pre-defined sets of compatibility rules. In some aspects, without full specification of the problem, the circuit-only input may be fed to a recommendation module, where the algorithm developer may receive a hint of possibility to activate the module for noise reduction.

One aspect to the invention may provide a method including augmenting a quantum approximate optimization algorithm (QAOA) quantum circuit. The quantum circuit may include a cost layer and/or a mixer layer. The cost layer may implement a unitary generated by a cost Hamiltonian. The mixer layer may implement an XY mixer that connects all qubits in a one-hot encoding block to all other qubits in the encoding block via unitary gates. Augmenting the quantum circuit may include adding to the quantum circuit 306 one or more encoders configured to perform unitary mapping of one-hot encoding basis states to basis states of a reduced number of qubits padded with one or more padding qubits in the zero computational basis state, mid-circuit measurements, conditional resets, and/or one or more decoders configured to perform unitary mapping from the basis states of the reduced number of qubits padded with the one or more padding qubits to one-hot encoding basis states. The mid-circuit measurements may be configured to cause one or more quantum processing units (QPUs) to measure one or more qubits of the augmented quantum circuit in the computational basis state. The one or more conditional resets may be configured to reset the augmented quantum circuit without full execution of a variational loop if one or more mid-circuit measurement results indicate that one or more qubits of the augmented quantum circuit are in an invalid state.

In some aspects, the mid-circuit measurements may be configured to cause the one or more QPUs to measure in the computational basis state one or more qubits of the augmented quantum circuit expected to be in the zero computational basis state. In some aspects, the one or more mid-circuit measurement results may indicate that the one or more qubits of the augmented quantum circuit are in the invalid state if the one or more mid-circuit measurement results indicate that at least one of the measured qubits is not in the zero computational basis state. In some aspects, the one or more mid-circuit measurement results may indicate that the one or more qubits of the augmented quantum circuit are in the invalid state if the one or more mid-circuit measurement results indicate that a number of measured qubits that are not in the zero computational basis state is greater than a non-zero threshold.

In some aspects, the method may further include validating the quantum circuit and corresponding encodings. In some aspects, the method may further include performing a hardware validation to determine an available mid-circuit measurement capability of the one or more QPUs. In some aspects, performing the hardware validation may include querying a local QPU for a mid-circuit measurement capability of the local QPU. In some aspects, performing the hardware validation may include making a dynamic and/or temporal query for an available mid-circuit measurement capability of one or more remote QPUs.

In some aspects, the method may further include performing validation matching that includes comparing a number k of qubits of the quantum circuit to the available mid-circuit measurement capability of the one or more quantum processing units (QPUs). In some aspects, if the validation matching determines that the available mid-circuit measurement capability is sufficient for mid-circuit measurements of the k qubits of the quantum circuit in the computational basis state, the mid-circuit measurements of the augmented quantum circuit may be configured to cause the one or more QPUs to measure the k qubits of the augmented quantum circuit in the computational basis state. In some aspects, if the validation matching determines that the available mid-circuit measurement capability is insufficient for mid-circuit measurements of the k qubits of the augmented quantum circuit in the computational basis state, the mid-circuit measurements of the augmented quantum circuit may be configured to cause the one or more QPUs to measure fewer than k qubits of the augmented quantum circuit in the computational basis state. In some aspects, the method may further include using a list of priority qubits to select the fewer than k qubits of the quantum circuit to be measured by the mid-circuit measurements of the augmented quantum circuit.

In some aspects, the one or more encoders may include one or more unary-binary basis change operators, and the one or more decoders may be one or more binary-unary basis change operators. In some aspects, the reduced number of qubits may be 1 (e.g., 1=ceiling(log 2(k)), the one or more padding qubits may include k−1 padding qubits, and the augmented quantum circuit may include k qubits.

In some aspects, the mid-circuit measurements may be configured to cause the one or more QPUs to measure one or more of the padding qubits of the augmented quantum circuit in the computational basis state. In some aspects, the augmented quantum circuit may include one or more ancilla qubits configured to take the mid-circuit measurements.

In some aspects, the method may further include compiling the augmented quantum circuit. In some aspects, the method may further include executing the compiled quantum circuit using at least the one or more QPUs. In some aspects, executing the compiled quantum circuit may include using the one or more QPUs to take the mid-circuit measurements to measure one or more qubits of the compiled quantum circuit in the computational basis state. In some aspects, executing the compiled quantum circuit may include determining that one or more mid-circuit measurement results indicate that one or more qubits of the compiled quantum circuit are in an invalid state. In some aspects, executing the compiled quantum circuit may include, if the one or more mid-circuit measurement results are determined to indicate that one or more qubits of the compiled quantum circuit are in an invalid state, resetting the compiled quantum circuit without full execution of a variational loop. In some aspects, the mid-circuit measurements may measure in the computational basis state one or more qubits of the compiled quantum circuit expected to be in the zero computational basis state, and the one or more mid-circuit measurement results may be determined to indicate that the one or more qubits of the compiled quantum circuit are in the invalid state if the one or more mid-circuit measurement results indicate that at least one measured qubit is (or greater than a non-zero threshold of measured qubits are) not in the zero computational basis state.

In some aspects, executing the compiled quantum circuit may include one-hot encoding of variables (e.g., Quadratic Unconstrained Binary Optimization (QUBO) or Polynomial Unconstrained Binary Optimization (PUBO) variables). In some aspects, executing the compiled quantum circuit may include using the one or more encoders to perform the unitary mapping of the one-hot encoding basis states to the basis states of the reduced number of qubits padded with the one or more padding qubits having the zero computational basis state. In some aspects, the reduced number of qubits may be 1 (e.g., 1=ceiling(log 2(k)), the one or more padding qubits may include k−1 padding qubits, and the compiled quantum circuit may include k qubits. In some aspects, executing the compiled quantum circuit may include using the one or more QPUs to take the mid-circuit measurements to measure one or more of the padding qubits of the compiled quantum circuit in the computational basis state.

In some aspects, executing the compiled quantum circuit may include using the one or more QPUs to determine parameters that optimize or approximately optimize an expectation value of a cost Hamiltonian. In some aspects, executing the compiled quantum circuit may include determining parameters by performing an optimization loop to optimize an expectation value of a cost Hamiltonian.

In some aspects, the method may further include returning optimization results. In some aspects, the method may further include generating a report including a quality of quantum circuit as measured compared to fully mid-circuit error mitigated quantum circuit on all qubits and/or a direct evaluation of cost saving during execution of the compiled quantum circuit as measured in filtered iterations (e.g., variational loops in which the compiled quantum circuit was reset without full execution of the variational loop) and corresponding saving in number of qubit operations.

Another aspect of the invention may provide a system adapted to augment a quantum approximate optimization algorithm (QAOA) quantum circuit. The quantum circuit may include a cost layer and/or a mixer layer. The cost layer may implement a unitary generated by a cost Hamiltonian. The mixer layer may implement an XY mixer that connects all qubits in a one-hot encoding block to all other qubits in the encoding block via unitary gates. Augmenting the quantum circuit may include adding to the quantum circuit one or more encoders configured to perform unitary mapping of one-hot encoding basis states to basis states of a reduced number of qubits padded with one or more padding qubits in the zero computational basis state, mid-circuit measurements, conditional resets, and/or one or more decoders configured to perform unitary mapping from the basis states of the reduced number of qubits padded with the one or more padding qubits to one-hot encoding basis states. The mid-circuit measurements may be configured to cause one or more quantum processing units (QPUs) to measure one or more qubits of the augmented quantum circuit in the computational basis state. The one or more conditional resets may be configured to reset the augmented quantum circuit without full execution of a variational loop if one or more mid-circuit measurement results indicate that one or more qubits of the augmented quantum circuit are in an invalid state.

Still another aspect of the invention may include a method including compiling an augmented quantum approximate optimization algorithm (QAOA) quantum circuit. The augmented quantum circuit may include a cost layer, a mixer layer, one or more encoders, mid-circuit measurements, and conditional resets. The cost layer may implement a unitary generated by a cost Hamiltonian. The mixer layer may implement an XY mixer that connects all qubits in a one-hot encoding block to all other qubits in the encoding block via unitary gates. The method may include executing the compiled quantum circuit. Executing the compiled quantum circuit may include using the one or more encoders configured to perform unitary mapping of one-hot encoding basis states to basis states of a reduced number of qubits padded with one or more padding qubits in the zero computational basis state. Executing the compiled quantum circuit may include using at least one or more quantum processing units (QPUs) to take the mid-circuit measurements by measuring one or more qubits of the compiled quantum circuit in the computational basis state. Executing the compiled quantum circuit may include determining that one or more mid-circuit measurement results indicate that one or more qubits of the compiled quantum circuit are in an invalid state. Executing the compiled quantum circuit may include, if the one or more mid-circuit measurement results are determined to indicate that the one or more qubits of the compiled quantum circuit are in the invalid state, resetting the compiled quantum circuit without full execution of a variational loop.

In some aspects, the mid-circuit measurements may measure one or more qubits of the compiled quantum circuit expected to be in the zero computational basis state. In some aspects, the one or more mid-circuit measurement results may be determined to indicate that the one or more qubits of the compiled quantum circuit are in the invalid state if the one or more mid-circuit measurement results indicate that at least one of the measured qubits is not in the zero computational basis state. In some aspects, the one or more mid-circuit measurement results may indicate that the one or more qubits of the compiled quantum circuit are in the invalid state if the one or more mid-circuit measurement results indicate that greater than a non-zero threshold of the measured qubits are not in the zero computational basis state.

In some aspects, executing the compiled quantum circuit may include using an encoder to perform a one-hot encoding of variables (e.g., Quadratic Unconstrained Binary Optimization (QUBO) or Polynomial Unconstrained Binary Optimization (PUBO) variables). In some aspects, the reduced number of qubits may be 1 (e.g., 1=ceiling(log 2(k)), the one or more padding qubits may include k−1 padding qubits, and the compiled quantum circuit may include k qubits.

In some aspects, the one or more measured qubits may be one or more of the padding qubits of the compiled quantum circuit. In some aspects, executing the compiled quantum circuit may include using one or more decoders to perform unitary mapping from the basis states of the reduced number of qubits padded with the one or more padding qubits to one-hot encoding basis states. In some aspects, executing the compiled quantum circuit may include using one or more ancilla qubits to take the mid-circuit measurements.

In some aspects, executing the compiled quantum circuit may include using at least the one or more QPUs to determine parameters that optimize or approximately optimize an expectation value of a cost Hamiltonian. In some aspects, executing the compiled quantum circuit may include determining parameters by performing an optimization loop to optimize an expectation value of a cost Hamiltonian.

Yet another aspect of the invention may include a system adapted to compile an augmented quantum approximate optimization algorithm (QAOA) quantum circuit. The augment quantum circuit may include a cost layer, a mixer layer, one or more encoders, mid-circuit measurements, and/or conditional resets. The cost layer may implement a unitary generated by a cost Hamiltonian. The mixer layer may implement an XY mixer that connects all qubits in a one-hot encoding block to all other qubits in the encoding block via unitary gates. The system may be adapted to execute the compiled quantum circuit. The system, in executing the compiled quantum circuit, may be adapted to use the one or more encoders configured to perform unitary mapping of one-hot encoding basis states to basis states of a reduced number of qubits padded with one or more padding qubits in the zero computational basis state. The system, in executing the compiled quantum circuit, may be adapted to use at least one or more quantum processing units (QPUs) to take the mid-circuit measurements by measuring one or more qubits of the compiled quantum circuit in the computational basis state. The system, in executing the compiled quantum circuit, may be adapted to determine that one or more mid-circuit measurement results indicate that one or more qubits of the compiled quantum circuit are in an invalid state. The system, in executing the compiled quantum circuit, may be adapted to, if the one or more mid-circuit measurement results are determined to indicate that the one or more qubits of the compiled quantum circuit are in the invalid state, reset the compiled quantum circuit without full execution of a variational loop.

Still another aspect of the invention may provide a computer program including instructions for adapting a system to perform any of the methods set forth above. Yet another aspect of the invention may provide a carrier containing the computer program, and the carrier may be one of an electronic signal, optical signal, radio signal, or compute readable storage medium.

Still another aspect of the invention may provide a system including processing circuitry and a memory. The memory may contain instructions executable by the processing circuitry, whereby the system is operative to perform any of the methods set forth above.

Yet another aspect of the invention may provide a system adapted to any of the methods set forth above.

Still another aspect of the invention may provide any combination of the aspects set forth above.

### BRIEF DESCRIPTION OF THE DRAWINGS

The accompanying drawings, which are incorporated herein and form part of the specification, illustrate various embodiments.

FIGS. 1A-1C illustrate systems according to some aspects.

FIG. 2 illustrates a system according to some aspects.

FIG. 3 illustrates a quantum circuit according to some aspects.

FIG. 4 is a flowchart illustrating a process according to some aspects.

FIG. 5 is a flowchart illustrating a process according to some aspects.

FIG. 6 is a flowchart illustrating a process according to some aspects.

FIG. 7 illustrates a system according to some aspects.

### DETAILED DESCRIPTION

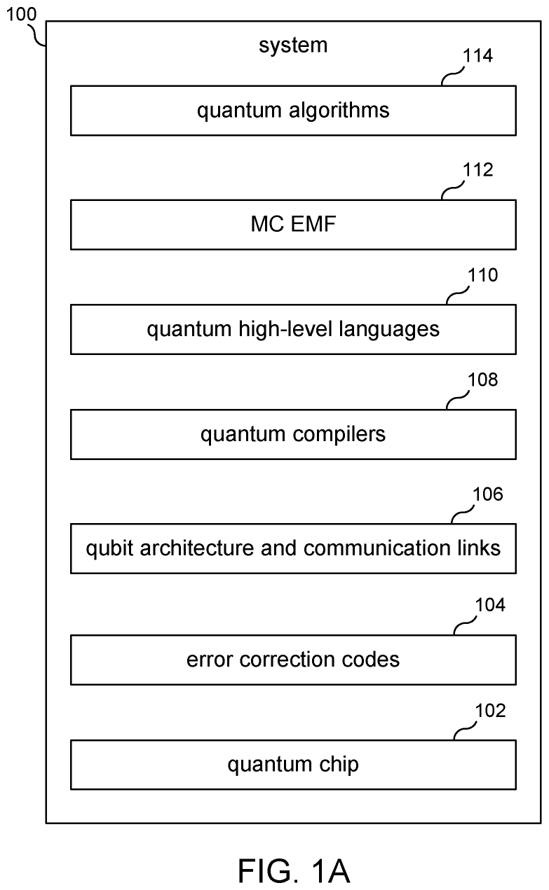

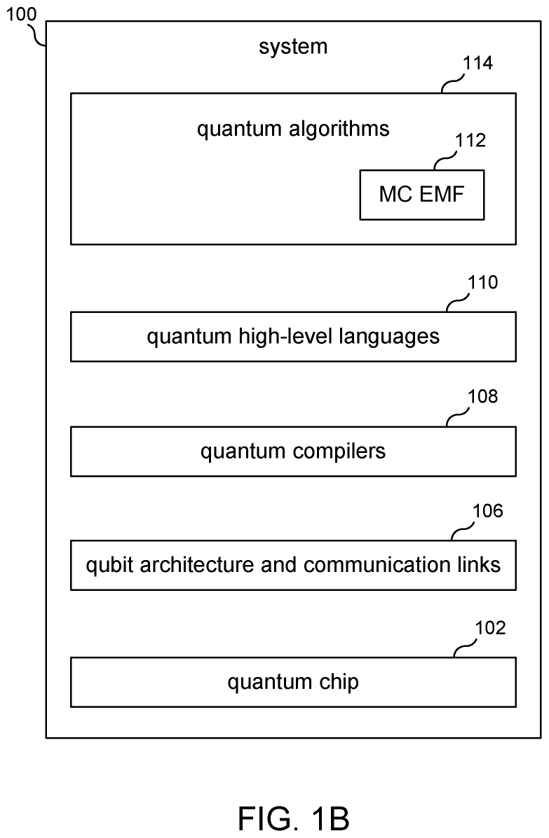

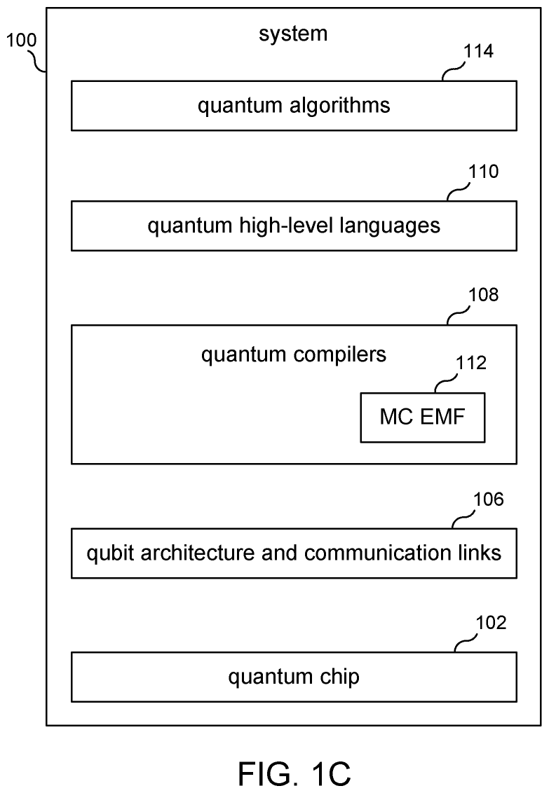

FIG. 1A is illustrates a system 100 for quantum computing according to some aspects. In some aspects, the system 100 may be a full-stack system for quantum computing. In some aspects, the system 100 may include the following general layers: a quantum chip 102, one or more error correcting codes 104, qubit architecture and one or more communication links 106, one or more quantum compilers 108, quantum high-level languages 110, mid-circuit (MC) error mitigation and filtering (EMF) 112, and/or one or more quantum algorithms 114. In some aspects, the system 100 may be implemented using a Near-Term Intermediate-Scale Quantum (NISQ) device. In some aspects, the system 100 may not include the one or more error correcting codes 104. In some aspects, the system 100 may not include one or more error correcting codes 104 and may be implemented using a NISQ device.

In some aspects, as shown in FIG. 1B, the MC EMF 112 may be within the quantum computing stack in the application level by modifying the one or more quantum algorithms 114. In these aspects, the MC EMF 112 may be configured to send an extended quantum circuit including mid-circuit measurements back to the device of the one or more quantum algorithms 114. In some aspects, as shown in FIG. 1C, the MC EMF 112 may additionally or alternatively be within the quantum computing stack at a lower level of the stack (e.g., in communication with the one or more quantum compilers 108) in the background. In these aspects, the MC EMF 112 may communicate (e.g., directly) the extended quantum circuit to the one or more quantum compilers 108 to be executed with the MC EMF extensions included.

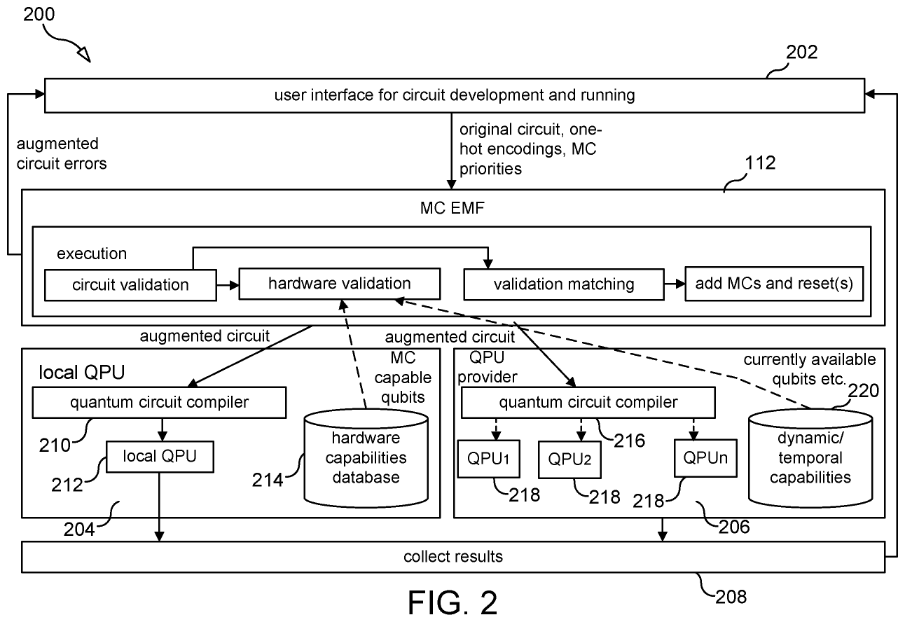

FIG. 2 illustrates the architecture of a system 200 for MC EMF according to some aspects. In some aspects, as shown in FIG. 2, the system 200 may include a user interface 202, an MC EMF module 112, a local quantum device 204, a remote quantum device 206, and/or a result collection and/or report generation module 208. In some aspects, the local quantum device 204 may include a quantum circuit compiler 210, one or more local quantum processing units (QPUs) 212, and/or a hardware capabilities database 214. In some aspects, the local quantum device 204 may be a local full stack device. In some aspects, the remote quantum device 206 may include a quantum circuit compiler 216, one or more remote QPUs 218, and/or a dynamic and/or temporal capabilities database 220. In some aspects, the remote quantum device 206 may be a remote-access full stack device. In some aspects, the remote quantum device 206 may be accessed via a cloud provider (e.g., a large cloud provider) of QPUs remotely connected to multiple physical backend options.

In some aspects, the MC EMF module 112 may be below the top layer of the end user interface 202 for circuit design to automatically augment an original quantum circuit of a variational quantum optimizer before execution of the quantum circuit. In some aspects, augmentation of the original quantum circuit may create an augmented quantum circuit. In some aspects, the augmented quantum circuit may be more efficient than the original quantum circuit. In some aspects, the augmented quantum circuit generated by the MC EMF module 112 may be sent to the local quantum device 204 and/or to the remote quantum device 206 for compiling by a quantum circuit compiler 210 or 216 and execution on one or more QPUs 212 and/or 218.

In some aspects, the MC EMF module 112 may perform circuit validation. In some aspects, the circuit validation may check the type of the original quantum circuit and/or the corresponding one-hot encoding.

In some aspects, the MC EMF module 112 may perform hardware validation. In some aspects, the hardware validation may check the available mid-circuit measurement capability of the local quantum device 204 and/or the remote quantum device 206. In some aspects, the hardware validation may determine the number of MC measurements that the local quantum device 204 and/or the remote quantum device 206 is capable of performing. In some aspects, the hardware validation may include querying the hardware capabilities database 214 of the local quantum device 204. In some aspects, the hardware validation may additionally or alternatively include a dynamic and/or temporal query for the currently available MC measurement capabilities of the remote quantum device 206 (e.g., via the dynamic and/or temporal capabilities database 220).

In some aspects, the MC EMF module 112 may perform validation matching. In some aspects, the validation matching may include comparing a number k of qubits of the original quantum circuit to the available mid-circuit measurement capability of the one or more QPUs 212 and/or 218.

In some aspects, the MC EMF module 112 may perform quantum circuit augmentation based on the result of validation matching. In some aspects, if the available mid-circuit measurement capability sufficient for the k qubits of the quantum circuit, the MC EMF module 112 may add MC measurements on all k qubits of the quantum circuit. In some aspects, if the available mid-circuit measurement capability is limited relative to the k qubits of the quantum circuit, the MC EMF module 112 may add MC measurements on fewer than all k qubits of the quantum circuit. In some aspects, the MC EMF module 112 may use a priority list to select the fewer than k qubits of the quantum circuit on which the MC measurements will be taken. In some aspects, additionally augment the quantum circuit with conditional qubit resets. In some aspects, the qubit resets may be configured to reset the quantum circuit based on MC measurement results. In some aspects, the MC EMF module 112 may augment the original quantum circuit using (i) one-hot encodings (e.g., received via the user interface 202) and/or (ii) the available mid-circuit measurement capability queried from the backend's QPU description databases 214 and/or 220.

In some aspects, the augmented quantum circuit generated by the MC EMF module 112 may be sent to the local quantum device 204 and/or to the remote quantum device 206 for compiling by a quantum circuit compiler 210 or 216 and execution on one or more QPUs 212 and/or 218. In some aspects, the one or more QPUs 212 and/or 218 may execute the augmented quantum circuit until convergence criteria of the variational optimization algorithm. In some aspects, the conditional resets may filter out (e.g., abort) iteration steps in the middle of the circuit without reaching an iteration evaluation at the end of circuit if there is at least one distorted variable with corresponding mid-circuit measurement in ancilla space (e.g., a variable measuring 1 instead of the expected 0 state).

In some aspects, after the optimization is finished, the result collection and/or report generation module 208 may generate optimization results. In some aspects, the result collection and/or report generation module 208 may additionally or alternatively generate a report (e.g., to complement the optimization results). In some aspects, the results and report may be provided to the user via the user interface 202. In some aspects, the report may have one or more description fields detailing (i) the quality of augment circuit as measured (e.g., by a limited amount of mid-circuit measurements) compared to fully MC error mitigated circuit on all variables; limitation reason (encoding error or of HW capabilities) and/or (ii) the comparison to other available hardware options. In some aspects, the optimization results may be conveyed to the MC EMF module 112, and the MC EMF module 112 may perform a direct evaluation of cost saving during optimization process as measured in filtered iterations and a corresponding saving in the number of qubit operations. In some aspects, the cost saving evaluation (e.g., the filtered iterations and/or the savings in number of qubit operations) may be included in the report.

In some alternative aspects, the MC EMF module 112 may be part of a local toolkit inserted in a high-level programming library (and not working in the background, directly connected to hardware information and compiler units as depicted in FIG. 2). In some of these alternative aspects, the process may be limited to circuit validation and augmentation (without hardware validation, validation matching, and quality report generation).

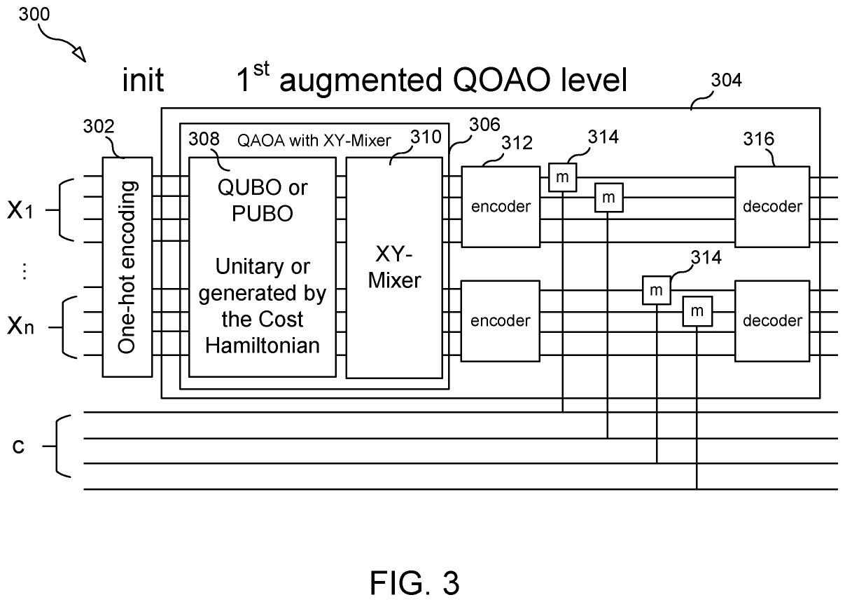

FIG. 3 illustrates a high-level diagram of a circuit 300 configured to use MC EMF operations for variational optimization. In some aspects, the circuit diagram illustrated in FIG. 3 may be a schematic representation of a single level augmented quantum approximate optimization algorithm (QAOA). In some aspects, the circuit 300 may include an encoder 302 and an augmented quantum circuit 304. In some aspects, the encoder 302 may be configured to perform a one-hot encoding of variables x₁, x₂, . . . xₙ (e.g., Quadratic Unconstrained Binary Optimization (QUBO) or Polynomial Unconstrained Binary Optimization (PUBO) variables). In some aspects, the perform initialization of the one-hot encodings. In some one-hot encoding aspects, encoding in which legal combinations of values are only those with a single bit is high and all other bits of the group of bits are low.

In some aspects, the augmented quantum circuit 304 may include the original quantum circuit 306. In some aspects, the original quantum circuit 306 may include a cost layer 308 and a mixer layer 310. In some aspects, the cost layer 308 may implement a unitary generated by a cost Hamiltonian (e.g., the exponentialization of the cost energy function). In some aspects, the mixer layer 310 may implement an XY mixer that is defined in the encoding space and connects all qubits in a one-hot encoding block to all other qubits in the encoding block via unitary gates. In some aspects, the XY mixer may connect all qubits to all others within the each one-hot encoding block via exp{iα(XᵢXⱼ+YᵢYⱼ)} unitary gates (where i,j runs over all qubits within encoding blocks).

In some aspects, the original quantum circuit 306 may solve a QUBO or higher level PUBO problem. In some aspects, the QUBO or PUBO variables x₁, x₂, . . . xₙ are one-hot encoded according to the logic of the underlying problem (e.g., for graph coloring n represents the number of the graph nodes to be colored, and the number k of the encoding to qubits is fixed by the number of colors to be used). In the augmented quantum circuit 304 illustrated in FIG. 3, k=4. In some aspects, as an initialization, the optimization may start from a uniform superposition of the quantum one-hot encoded states (e.g., W-states).

In some aspects, augmenting the augmented quantum circuit 304 may include one or more encoders 312 (e.g., V encoders) configured to perform unitary mapping of one-hot encoding basis states to basis states of a reduced number of qubits padded with one or more padding qubits in the zero computational basis state, mid-circuit measurements 314, conditional resets, and/or one or more decoders 316 (e.g., V⁺ decoders) configured to perform unitary mapping from the basis states of the reduced number of qubits padded with the one or more padding qubits to one-hot encoding basis states. In some aspects, the reduced number of qubits may be 1 (e.g., 1=ceiling(log 2(k)), the one or more padding qubits may include k−1 padding qubits, and the compiled quantum circuit 304 may include k qubits.

In some aspects, the mid-circuit measurements 314 may measure the padding qubits (e.g., the k−1 qubits containing the padded zeros). In some aspects, the mid-circuit measurement results may be written into the classical registers c. In some aspects, a classical computer may use the mid-circuit measurement results (e.g., in the classical registers c) to decide whether to abort the circuit (e.g., if the sum is non-zero or, in a more relaxed version, if the sum is over a preset threshold value). In some aspects, the mid-circuit measurements may be restricted to the most important or priority qubits (e.g., based on qubit quality, where overall cost consideration can leverage a selective mid-point checking variant). In some aspects, the mid-circuit measurements may be used as an extension after each level of QAOA.

In some aspects, the single-level QAOA illustrated in FIG. 3 may be generalized to a P-level QAOA. In some aspects, as the general structure of the QAOA is composed of p>0 repeated levels after initialization of the circuit, there may be freedom in choosing the filtering strategy. In some aspects, the mid-circuit measurements may be done after each level. In some alternative aspects, the mid-circuit measurements may be performed only after every kth level in the different groups. In some aspects, the strategy may be optimized based on knowledge of the qubit qualities and the mid-circuit measurement quality.

In some aspects, the system 100 and/or 200 may use one or more of input parameters (e.g., received via the user interface 202, via an application programming interface, and/or from a device 204 or 206) to automatically generate the original quantum circuit 306 and the augmented quantum circuit 304. In some aspects, the input parameters may include problem parameters, hyper parameters, and/or device parameters. In some aspects, the problem parameters (e.g., received from a user) may include: (i) n: the number of problem-specific variables (e.g., number of vertices in graph coloring or number of cliques in clique cover problem), (ii) k: the number of one-hot encoded qubits, and/or (iii) a cost Hamiltonian to generate the unitary automatically. In some aspects, the hyper parameters (e.g., received from a user) may include (i) p: level of QAOA and/or (ii) f: mid-circuit measurement frequency for an optimal strategy. In some aspects, the device parameters (e.g., received from the user and/or the device) may include (i) q: qubit qualities and/or (ii) t: priority list threshold. In some aspects, the default priority list threshold may be all (e.g., all qubits). In some aspects, the system 100 and/or 200 may generate an augmented quantum circuit 304 including the unitary generated by the Cost Hamiltonian 308, XY-Mixer 310, the V operators 312 and 316, the mid-circuit measurements 314, and the conditional resets.

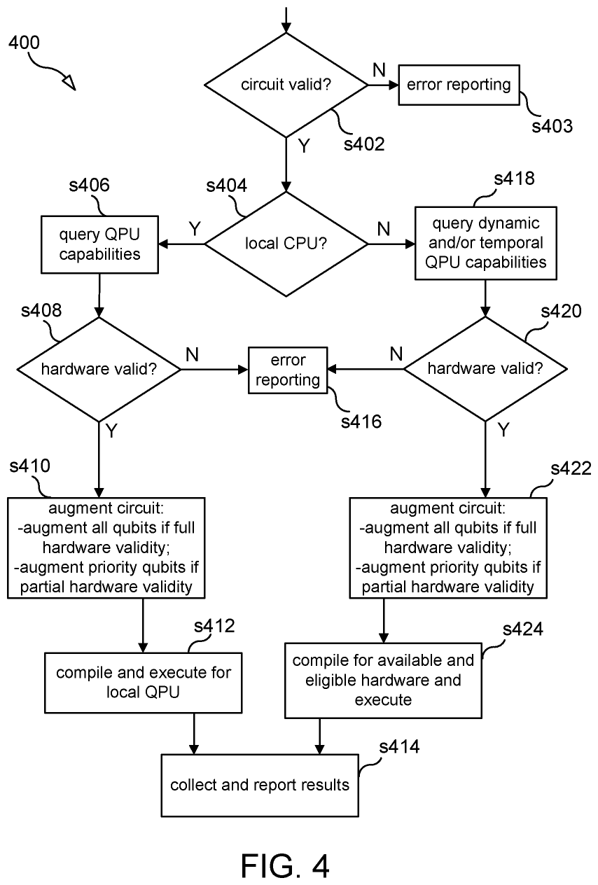

FIG. 4 illustrates a process 400 performed by a system (e.g., the system 100 and/or 200 and/or the quantum circuit 300) according to some aspects. The process 400 may be an overall process using various backend options.

In some aspects, the process 400 may include a circuit validation step 402 in which an original quantum circuit 306 and corresponding encodings (e.g., received from the user interface 202) is validated.

In some aspects, the process 400 may include an error reporting step 403. In some aspects, the process 400 may proceed from the circuit validation step 402 in the case of circuit invalidity. In some aspects, the step 403 may include sending an error report to the user interface 202.

In some aspects, the process 400 may include a step 404 in which the system 100 and/or 200 determines whether a local quantum device 204 or a remote quantum device 206 will be used to compile and execute the quantum circuit. In some aspects, if a local quantum device 204 will be used, the process 400 may proceed from the step 404 to a hardware validation step 406. In some aspects, the hardware validation step 406 may include querying QPU capabilities from the available backend descriptor database 214 of the local quantum device 204. In some aspects, if a remote quantum device 206 will be used, the process 400 may proceed from the step 404 to a hardware validation step 418. In some aspects, the hardware validation step 418 may include querying dynamic and/or temporal QPU capabilities from the available backend descriptor database 220 of the remote quantum device 206.

In some aspects, the process 400 may include a quantum circuit augmentation step 410 (if a local quantum device 204 will be used) and a quantum circuit augmentation step 422 (if a remote quantum device 206 will be used). In some aspects, the quantum circuit augmentation steps 410 and 422 may include, if validation returns a fully matched software and hardware pair (e.g., if the available mid-circuit measurement capability is sufficient to perform mid-circuit measurements on all qubit encodings), augmenting all qubit encodings with MC measurement and error mitigation operations (e.g., conditional resets). In some aspects, the quantum circuit augmentation steps 410 and 422 may include, if validation returns a partial software and hardware match (e.g., if the available mid-circuit measurement capability is insufficient to perform mid-circuit measurements on all qubit encodings), augmenting fewer than all of the qubit encodings with MC measurement error and mitigation operations (e.g., conditional resets). In some aspects, augmenting fewer than all of the qubit encodings with MC measurement error and mitigation operations may include mapping priority variables (e.g., as identified by the priority list) to MC measurement capable qubits.

In some aspects, the process 400 may include a compiling and execution step 412 (if a local quantum device 204 will be used) and a compiling and execution step 424 (if a remote quantum device 206 will be used). In some aspects, the compiling and execution step 412 may include the quantum circuit compiler 210 of the local quantum device 204 compiling the augmented quantum circuit and one or more local QPUs 212 executing the compiled quantum circuit. In some aspects, the compiling and execution step 424 may include the quantum circuit compiler 216 of the remote quantum device 206 compiling the augmented quantum circuit and one or more remote QPUs 218 executing the compiled quantum circuit.

In some aspects, the process 400 may include a result collection and/or report generation step 414. In some aspects, the step 414 may include sending run results to the user interface 202.

In some aspects, the process 400 may include an error reporting step 416. In some aspects, the process 400 may proceed from the hardware validation step 408 or 420 in the case of hardware and software incompatibility. In some aspects, the step 416 may include sending an error report to the user interface 202.

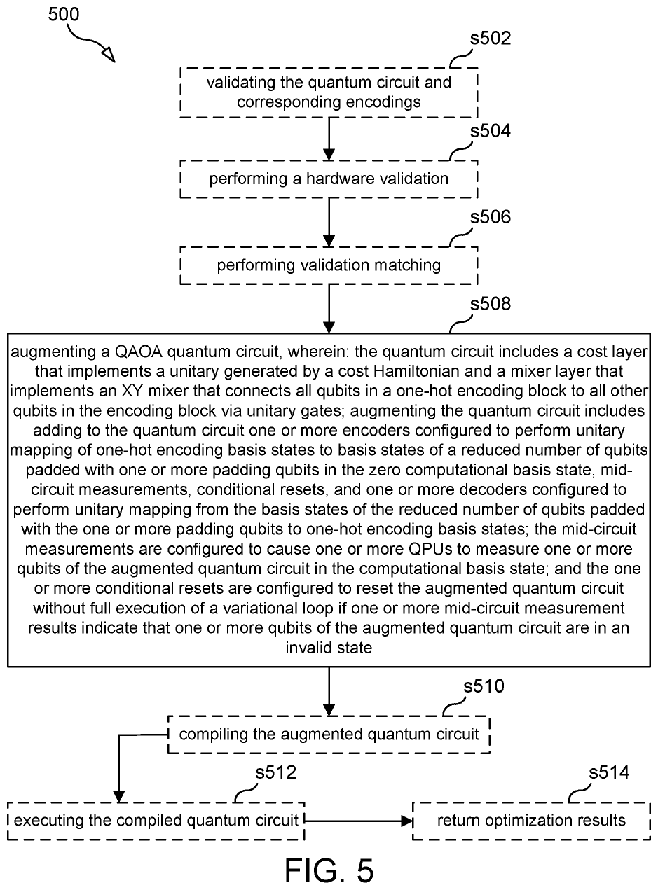

FIG. 5 illustrates a process 500 performed by a system (e.g., the system 100 and/or 200 and/or the quantum circuit 300) according to some aspects.

In some aspects, the process 500 may include an optional step 502 in which the system 100 and/or 200 validates a quantum approximate optimization algorithm (QAOA) quantum circuit 304 and corresponding encodings.

In some aspects, the process 500 may include an optional step 504 in which the system 100 and/or 200 performs a hardware validation to determine an available mid-circuit measurement capability of one or more quantum processing units (QPUs) 212 and/or 218. In some aspects, performing the hardware validation in step 504 may include the system 100 and/or 200 querying a local QPU 212 for a mid-circuit measurement capability of the local QPU 212. In some aspects, performing the hardware validation in step 504 may additionally or alternatively include the system 100 and/or 200 making a dynamic and/or temporal query for an available mid-circuit measurement capability of one or more remote QPUs 218.

In some aspects, the process 500 may include an optional step 506 in which the system 100 and/or 200 performs validation matching that includes comparing a number k of qubits of the QAOA quantum circuit 304 to the available mid-circuit measurement capability of the one or more QPUs 212 and/or 218.

In some aspects, the process 500 may include a step 508 in which the system 100 and/or 200 augments the QAOA quantum circuit 306. In some aspects, the quantum circuit 306 may include a cost layer 308 and/or a mixer layer 310. In some aspects, the cost layer 308 may implement a unitary generated by a cost Hamiltonian. In some aspects, the mixer layer 310 may implement an XY mixer that connects all qubits in a one-hot encoding block to all other qubits in the encoding block via unitary gates. In some aspects, augmenting the quantum circuit 306 may include adding to the quantum circuit 306 one or more encoders 312 configured to perform unitary mapping of one-hot encoding basis states to basis states of a reduced number of qubits padded with one or more padding qubits in the zero computational basis state, mid-circuit measurements 314, conditional resets, and/or one or more decoders 316 configured to perform unitary mapping from the basis states of the reduced number of qubits padded with the one or more padding qubits to one-hot encoding basis states. In some aspects, the mid-circuit measurements 314 may be configured to cause one or more quantum processing units (QPUs) 212 and/or 218 to measure one or more qubits of the augmented quantum circuit 304 in the computational basis state. In some aspects, the one or more conditional resets may be configured to reset the augmented quantum circuit 304 without full execution of a variational loop if one or more mid-circuit measurement results indicate that one or more qubits of the augmented quantum circuit 304 are in an invalid state.

In some aspects, the mid-circuit measurements 314 may be configured to cause the one or more QPUs 212 and/or 218 to measure in the computational basis state one or more qubits of the augmented quantum circuit 304 expected to be in the zero computational basis state. In some aspects, the one or more mid-circuit measurement results may indicate that the one or more qubits of the augmented quantum circuit 304 are in the invalid state if the one or more mid-circuit measurement results indicate that at least one of the measured qubits is not in the zero computational basis state. In some aspects, the one or more mid-circuit measurement results may indicate that the one or more qubits of the augmented quantum circuit 304 are in the invalid state if the one or more mid-circuit measurement results indicate that a number of measured qubits that are not in the zero computational basis state is greater than a non-zero threshold.

In some aspects, the one or more encoders 312 may include one or more unary-binary basis change operators, and the one or more decoders 316 may be one or more binary-unary basis change operators. In some aspects, the reduced number of qubits may be 1 (e.g., 1=ceiling(log 2(k)), the one or more padding qubits may include k−1 padding qubits, and the augmented quantum circuit 304 may include k qubits.

In some aspects, the mid-circuit measurements 314 may be configured to cause the one or more QPUs 212 and/or 218 to measure one or more of the padding qubits of the augmented quantum circuit 304 in the computational basis state. In some aspects, the augmented quantum circuit 304 may include one or more ancilla qubits configured to take the mid-circuit measurements 314.

In some aspects, if the validation matching in the optional step 506 determines that the available mid-circuit measurement capability is sufficient for mid-circuit measurements of the k qubits of the quantum circuit 306 in the computational basis state, the mid-circuit measurements 314 of the augmented quantum circuit 304 may be configured to cause the one or more QPUs 212 and/or 218 to measure the k qubits of the augmented quantum circuit 304 in the computational basis state. In some aspects, if the validation matching in the optional step 506 determines that the available mid-circuit measurement capability is insufficient for mid-circuit measurements of the k qubits of the quantum circuit 306 in the computational basis state, the mid-circuit measurements 314 of the augmented quantum circuit 304 may be configured to cause the one or more QPUs 212 and/or 218 to measure fewer than k qubits of the augmented quantum circuit 304 in the computational basis state. In some aspects, the optional step 506 may include using a list of priority qubits to select the fewer than k qubits of the augmented quantum circuit 304 to be measured by the mid-circuit measurements 314 of the augmented quantum circuit 304.

In some aspects, the process 500 may include an optional step 510 in which the system 100 and/or 200 compiles the augmented quantum circuit 304.

In some aspects, the process 500 may include an optional step 512 in which the system 100 and/or 200 executes the compiled quantum circuit 304 using at least the one or more QPUs 212 and/or 218. In some aspects, executing the compiled quantum circuit 304 in the optional step 512 may include using the one or more QPUs 212 and/or 218 to take the mid-circuit measurements 314 to measure one or more qubits of the compiled quantum circuit 304 in the computational basis state. In some aspects, executing the compiled quantum circuit 304 in the optional step 512 may include determining that one or more mid-circuit measurement results indicate that one or more qubits of the compiled quantum circuit 304 are in an invalid state. In some aspects, executing the compiled quantum circuit 304 in the optional step 512 may include, if the one or more mid-circuit measurement results are determined to indicate that one or more qubits of the compiled quantum circuit 304 are in an invalid state, resetting the compiled quantum circuit 304 without full execution of a variational loop. In some aspects, the mid-circuit measurements 314 may measure in the computational basis state one or more qubits of the compiled quantum circuit 304 expected to be in the zero computational basis state, and the one or more mid-circuit measurement results may be determined to indicate that the one or more qubits of the compiled quantum circuit 304 are in the invalid state if the one or more mid-circuit measurement results indicate that at least one measured qubit is (or greater than a non-zero threshold of measured qubits are) not in the zero computational basis state.

In some aspects, executing the compiled quantum circuit 304 in the optional step 512 may include one-hot encoding of variables (e.g., Quadratic Unconstrained Binary Optimization (QUBO) or Polynomial Unconstrained Binary Optimization (PUBO) variables). In some aspects, executing the compiled quantum circuit 304 in the optional step 512 may include using the one or more encoders 312 to perform the unitary mapping of the one-hot encoding basis states to the basis states of the reduced number of qubits padded with the one or more padding qubits having the zero computational basis state. In some aspects, the reduced number of qubits may be 1 (e.g., 1=ceiling(log 2(k)), the one or more padding qubits may include k−1 padding qubits, and the compiled quantum circuit 304 may include k qubits. In some aspects, executing the compiled quantum circuit 304 may include using the one or more QPUs 212 and/or 218 to take the mid-circuit measurements 314 to measure one or more of the padding qubits of the compiled quantum circuit 304 in the computational basis state.

In some aspects, executing the compiled quantum circuit 304 in the optional step 512 may include using the one or more QPUs 212 and/or 218 to determine parameters that optimize or approximately optimize an expectation value of a cost Hamiltonian. In some aspects, executing the compiled quantum circuit 304 in the optional step 512 may include determining parameters by performing an optimization loop to optimize an expectation value of a cost Hamiltonian.

In some aspects, the process 500 may include an optional step 514 in which the system 100 and/or 200 returns optimization results (e.g., via the user interface 202). In some aspects, the optional step 514 may additionally or alternatively include generating a report. In some aspects, the report may include a quality of quantum circuit as measured compared to fully mid-circuit error mitigated quantum circuit on all qubits and/or a direct evaluation of cost saving during execution of the compiled quantum circuit 304 as measured in filtered iterations (e.g., variational loops in which the compiled quantum circuit 304 was reset without full execution of the variational loop) and corresponding saving in number of qubit operations.

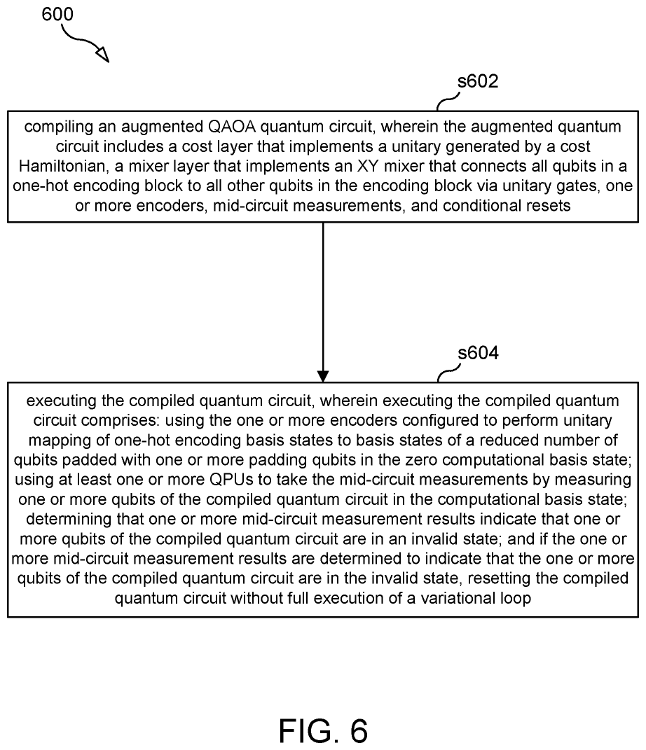

FIG. 6 illustrates a process 600 performed by a system (e.g., the system 100 and/or 200 and/or the quantum circuit 300) according to some aspects.

In some aspects, the process 600 may include a step 602 in which the system 100 and/or 200 compiles an augmented quantum approximate optimization algorithm (QAOA) quantum circuit 304. In some aspects, the augmented quantum circuit 304 may include a cost layer 308, a mixer layer 310, one or more encoders 312, mid-circuit measurements 314, and/or conditional resets. In some aspects, the cost layer 308 may implement a unitary generated by a cost Hamiltonian. In some aspects, the mixer layer 310 may implement an XY mixer that connects all qubits in a one-hot encoding block to all other qubits in the encoding block via unitary gates.

In some aspects, the process 600 may include a step 604 in which the system 100 and/or 200 executes the compiled quantum circuit 304. In some aspects, executing the compiled quantum circuit 304 may include using the one or more encoders 312 configured to perform unitary mapping of one-hot encoding basis states to basis states of a reduced number of qubits padded with one or more padding qubits in the zero computational basis state. In some aspects, executing the compiled quantum circuit 304 may include using at least one or more quantum processing units (QPUs) 212 and/or 218 to take the mid-circuit measurements 314 by measuring one or more qubits of the compiled quantum circuit 304 in the computational basis state. In some aspects, executing the compiled quantum circuit 304 may include determining that one or more mid-circuit measurement results indicate that one or more qubits of the compiled quantum circuit 304 are in an invalid state. In some aspects, executing the compiled quantum circuit 304 may include, if the one or more mid-circuit measurement results are determined to indicate that the one or more qubits of the compiled quantum circuit 304 are in the invalid state, resetting the compiled quantum circuit 304 without full execution of a variational loop.

In some aspects, the mid-circuit measurements 314 may measure one or more qubits of the compiled quantum circuit 304 expected to be in the zero computational basis state. In some aspects, the one or more mid-circuit measurement results may be determined to indicate that the one or more qubits of the compiled quantum circuit 304 are in the invalid state if the one or more mid-circuit measurement results indicate that at least one of the measured qubits is not in the zero computational basis state. In some aspects, the one or more mid-circuit measurement results may indicate that the one or more qubits of the compiled quantum circuit 304 are in the invalid state if the one or more mid-circuit measurement results indicate that greater than a non-zero threshold of the measured qubits are not in the zero computational basis state.

In some aspects, executing the compiled quantum circuit 304 in step 604 may include using an encoder 302 to perform a one-hot encoding of variables (e.g., Quadratic Unconstrained Binary Optimization (QUBO) or Polynomial Unconstrained Binary Optimization (PUBO) variables). In some aspects, the reduced number of qubits may be 1 (e.g., 1=ceiling(log 2(k)), the one or more padding qubits may include k−1 padding qubits, and the compiled quantum circuit 304 may include k qubits.

In some aspects, the one or more measured qubits may be one or more of the padding qubits of the compiled quantum circuit 304. In some aspects, executing the compiled quantum circuit 304 in the step 604 may include using one or more decoders 316 to perform unitary mapping from the basis states of the reduced number of qubits padded with the one or more padding qubits to one-hot encoding basis states. In some aspects, executing the compiled quantum circuit 304 in the step 604 may include using one or more ancilla qubits to take the mid-circuit measurements.

In some aspects, executing the compiled quantum circuit 304 in the step 604 may include using at least the one or more QPUs 212 and/or 218 to determine parameters that optimize or approximately optimize an expectation value of a cost Hamiltonian. In some aspects, executing the compiled quantum circuit 304 in the step 604 may include determining parameters by performing an optimization loop to optimize an expectation value of a cost Hamiltonian.

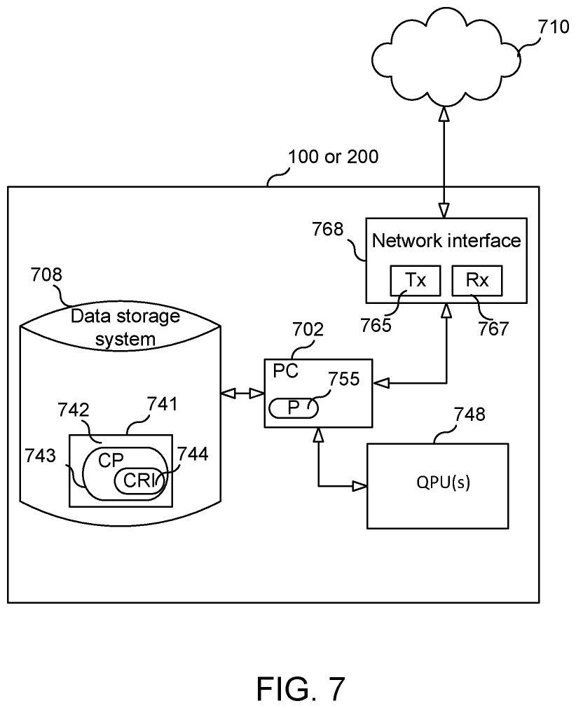

FIG. 7 is a block diagram of all or a portion of a system (e.g., the system 100 and/or 200 and/or the quantum circuit 300) according to some aspects. As shown in FIG. 7, the system 100 and/or 200 may comprise: processing circuitry (PC) 702, which may include one or more processors (P) 755 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., the system may be a distributed computing apparatus); a network interface 768 comprising a transmitter (Tx) 765 and a receiver (Rx) 767 for enabling the system 100 and/or 200 to transmit data to and receive data from other nodes connected to a network 710 (e.g., an Internet Protocol (IP) network) to which network interface 768 is connected; one or more QPU(s) 648 (e.g., QPU(s) 212 and/or 218); and a local storage unit (a.k.a., “data storage system”) 708, which may include one or more non-volatile storage devices and/or one or more volatile storage devices. In aspects where PC 702 includes a programmable processor, a computer program product (CPP) 741 may be provided. In some aspects, the CPP 741 may include a computer readable medium (CRM) 742 storing a computer program (CP) 743 comprising computer readable instructions (CRI) 744. In some aspects, the CRM 742 may be a non-transitory computer readable medium, such as, magnetic media (e.g., a hard disk), optical media, memory devices (e.g., random access memory, flash memory), and the like. In some aspects, the CRI 744 of computer program 743 may be configured such that when executed by PC 702, the CRI causes the system 100 and/or 200 to perform steps described herein (e.g., one or more steps described herein with reference to the flowcharts herein). In other aspects, the system 100 and/or 200 may be configured to perform steps described herein without the need for code. That is, for example, the PC 702 may consist merely of one or more ASICs. Hence, the features of the aspects described herein may be implemented in hardware and/or software.

In some aspects, the methods and system described herein may be implemented via a cloud. In some aspects, some or all of the quantum hardware may be placed within a generic cloud center or as parts of a separate quantum cloud infrastructure. In some aspects, the MC EMF methods described herein may be used as a service, accessed by the end user via higher level application programming interface (API) for specific optimization tasks, and/or run in the background as integrated part of the full-stack quantum compute resource.

### Summary of Embodiments

A1. A method (500) comprising: augmenting a quantum approximate optimization algorithm (QAOA) quantum circuit (306), wherein: the quantum circuit includes a cost layer (308) that implements a unitary generated by a cost Hamiltonian and a mixer layer (310) that implements an XY mixer that connects all qubits in a one-hot encoding block to all other qubits in the encoding block via unitary gates; augmenting the quantum circuit includes adding to the quantum circuit one or more encoders (312) configured to perform unitary mapping of one-hot encoding basis states to basis states of a reduced number of qubits padded with one or more padding qubits in the zero computational basis state, mid-circuit measurements (314), conditional resets, and one or more decoders (316) configured to perform unitary mapping from the basis states of the reduced number of qubits padded with the one or more padding qubits to one-hot encoding basis states; the mid-circuit measurements are configured to cause one or more quantum processing units (QPUs) (212 or 218) to measure one or more qubits of the augmented quantum circuit (304) in the computational basis state; and the one or more conditional resets are configured to reset the augmented quantum circuit without full execution of a variational loop if one or more mid-circuit measurement results indicate that one or more qubits of the augmented quantum circuit are in an invalid state.
A2. The method of embodiment A1, wherein the mid-circuit measurements are configured to cause the one or more QPUs to measure in the computational basis state one or more qubits of the augmented quantum circuit expected to be in the zero computational basis state.
A3. The method of embodiment A2, wherein the one or more mid-circuit measurement results indicate that the one or more qubits of the augmented quantum circuit are in the invalid state if the one or more mid-circuit measurement results indicate that at least one of the measured qubits is not in the zero computational basis state.
A4. The method of embodiment A2, wherein the one or more mid-circuit measurement results indicate that the one or more qubits of the augmented quantum circuit are in the invalid state if the one or more mid-circuit measurement results indicate that a number of measured qubits that are not in the zero computational basis state is greater than a non-zero threshold.
A5. The method of any one of embodiments A1-A4, further comprising validating the quantum circuit and corresponding encodings.
A6. The method of embodiment A5, further comprising performing a hardware validation to determine an available mid-circuit measurement capability of the one or more QPUs.
A7. The method of embodiment A6, wherein performing the hardware validation comprises querying a local QPU (212) for a mid-circuit measurement capability of the local QPU.
A8. The method of embodiment A6, wherein performing the hardware validation comprises making a dynamic and/or temporal query for an available mid-circuit measurement capability of one or more remote QPUs (218).
A9. The method of any one of embodiments A6-A8, further comprising performing validation matching that includes comparing a number k of qubits of the quantum circuit to the available mid-circuit measurement capability of the one or more quantum processing units (QPUs).
A10. The method of embodiment A9, further comprising, if the validation matching determines that the available mid-circuit measurement capability is sufficient for mid-circuit measurements of the k qubits of the quantum circuit in the computational basis state, the mid-circuit measurements of the augmented quantum circuit are configured to cause the one or more QPUs to measure the k qubits of the augmented quantum circuit in the computational basis state.
A11. The method of embodiment A9, further comprising, if the validation matching determines that the available mid-circuit measurement capability is insufficient for mid-circuit measurements of the k qubits of the quantum circuit in the computational basis state, the mid-circuit measurements of the augmented quantum circuit are configured to cause the one or more QPUs to measure fewer than k qubits of the augmented quantum circuit in the computational basis state.
A12. The method of embodiment A11, further comprising using a list of priority qubits to select the fewer than k qubits of the quantum circuit to be measured by the mid-circuit measurements of the augmented quantum circuit.
A13. The method of any one of embodiments A1-A12, wherein the one or more encoders comprise one or more unary-binary basis change operators, and the one or more decoders are one or more binary-unary basis change operators.
A14. The method of any one of embodiments A1-A13, wherein the reduced number of qubits is 1 (e.g., 1=ceiling(log 2(k)), the one or more padding qubits include k−1 padding qubits, and the augmented quantum circuit includes k qubits.
A15. The method of any one of embodiments A1-A14, wherein the mid-circuit measurements are configured to cause the one or more QPUs to measure one or more of the padding qubits of the augmented quantum circuit in the computational basis state.
A16. The method of any one of embodiments A1-A15, wherein the augmented quantum circuit comprises one or more ancilla qubits configured to take the mid-circuit measurements.
A17. The method of any one of embodiments A1-A16, further comprising compiling the augmented quantum circuit.
A18. The method of embodiment A17, further comprising executing the compiled quantum circuit (304) using at least the one or more QPUs.
A19. The method of embodiment A18, wherein executing the compiled quantum circuit comprises using the one or more QPUs to take the mid-circuit measurements to measure one or more qubits of the compiled quantum circuit in the computational basis state.
A20. The method of embodiment A19, wherein executing the compiled quantum circuit comprises: determining that one or more mid-circuit measurement results indicate that one or more qubits of the compiled quantum circuit are in an invalid state; if the one or more mid-circuit measurement results are determined to indicate that one or more qubits of the compiled quantum circuit are in an invalid state, resetting the compiled quantum circuit without full execution of a variational loop.
A21. The method of embodiment A20, wherein the mid-circuit measurements measure in the computational basis state one or more qubits of the compiled quantum circuit expected to be in the zero computational basis state, and the one or more mid-circuit measurement results are determined to indicate that the one or more qubits of the compiled quantum circuit are in the invalid state if the one or more mid-circuit measurement results indicate that at least one measured qubit is (or greater than a non-zero threshold of measured qubits are) not in the zero computational basis state.
A22. The method of any one of embodiments A18-A21, wherein executing the compiled quantum circuit comprises one-hot encoding of variables (e.g., Quadratic Unconstrained Binary Optimization (QUBO) or Polynomial Unconstrained Binary Optimization (PUBO) variables).
A23. The method of any one of embodiments A18-A22, wherein executing the compiled quantum circuit comprises using the one or more encoders to perform the unitary mapping of the one-hot encoding basis states to the basis states of the reduced number of qubits padded with the one or more padding qubits having the zero computational basis state.
A24. The method of embodiment A23, wherein the reduced number of qubits is 1 (e.g., 1=ceiling(log 2(k)), the one or more padding qubits include k−1 padding qubits, and the compiled quantum circuit includes k qubits.
A25. The method of embodiment A23 or A24, wherein executing the compiled quantum circuit comprises using the one or more QPUs to take the mid-circuit measurements to measure one or more of the padding qubits of the compiled quantum circuit in the computational basis state.
A26. The method of any one of embodiments A18-A25, wherein executing the compiled quantum circuit comprises using the one or more QPUs to determine parameters that optimize or approximately optimize an expectation value of a cost Hamiltonian.
A27. The method of any one of embodiments A18-A26, wherein executing the compiled quantum circuit comprises determining parameters by performing an optimization loop to optimize an expectation value of a cost Hamiltonian.
A28. The method of any one of embodiments A18-A27, further comprising returning optimization results.
A29. The method of any one of embodiments A18-A28, further comprising generating a report including a quality of quantum circuit as measured compared to fully mid-circuit error mitigated quantum circuit on all qubits and/or a direct evaluation of cost saving during execution of the compiled quantum circuit as measured in filtered iterations (e.g., variational loops in which the compiled quantum circuit was reset without full execution of the variational loop) and corresponding saving in number of qubit operations.
B1. A system (100 and/or 200) adapted to: augment a quantum approximate optimization algorithm (QAOA) quantum circuit (306), wherein: the quantum circuit includes a cost layer (308) that implements a unitary generated by a cost Hamiltonian and a mixer layer (310) implements an XY mixer that connects all qubits in a one-hot encoding block to all other qubits in the encoding block via unitary gates; augmenting the quantum circuit includes adding to the quantum circuit one or more encoders (312) configured to perform unitary mapping of one-hot encoding basis states to basis states of a reduced number of qubits padded with one or more padding qubits in the zero computational basis state, mid-circuit measurements (314), conditional resets, and one or more decoders (316) configured to perform unitary mapping from the basis states of the reduced number of qubits padded with the one or more padding qubits to one-hot encoding basis states; the mid-circuit measurements are configured to cause one or more quantum processing units (QPUs) (212 or 218) to measure one or more qubits of the augmented quantum circuit (304) in the computational basis state; and the one or more conditional resets are configured to reset the augmented quantum circuit without full execution of a variational loop if one or more mid-circuit measurement results indicate that one or more qubits of the augmented quantum circuit are in an invalid state.
C1. A method (600) comprising: compiling an augmented quantum approximate optimization algorithm (QAOA) quantum circuit (304), wherein the augmented quantum circuit includes a cost layer (308) that implements a unitary generated by a cost Hamiltonian, a mixer layer (310) that implements an XY mixer that connects all qubits in a one-hot encoding block to all other qubits in the encoding block via unitary gates, one or more encoders (312), mid-circuit measurements (314), and conditional resets; and executing the compiled quantum circuit (304), wherein executing the compiled quantum circuit comprises: using the one or more encoders configured to perform unitary mapping of one-hot encoding basis states to basis states of a reduced number of qubits padded with one or more padding qubits in the zero computational basis state; using at least one or more quantum processing units (QPUs) (212 or 218) to take the mid-circuit measurements by measuring one or more qubits of the compiled quantum circuit in the computational basis state; determining that one or more mid-circuit measurement results indicate that one or more qubits of the compiled quantum circuit are in an invalid state; and, if the one or more mid-circuit measurement results are determined to indicate that the one or more qubits of the compiled quantum circuit are in the invalid state, resetting the compiled quantum circuit without full execution of a variational loop.
C2. The method of embodiment C1, wherein the mid-circuit measurements measure one or more qubits of the compiled quantum circuit expected to be in the zero computational basis state.
C3. The method of embodiment C2, wherein the one or more mid-circuit measurement results are determined to indicate that the one or more qubits of the compiled quantum circuit are in the invalid state if the one or more mid-circuit measurement results indicate that at least one of the measured qubits is not in the zero computational basis state.
C4. The method of embodiment C2, wherein the one or more mid-circuit measurement results indicate that the one or more qubits of the compiled quantum circuit are in the invalid state if the one or more mid-circuit measurement results indicate that greater than a non-zero threshold of the measured qubits are not in the zero computational basis state.
C5. The method of any one of embodiments C1-C4, wherein executing the compiled quantum circuit comprises using an encoder (302) to perform a one-hot encoding of variables (e.g., Quadratic Unconstrained Binary Optimization (QUBO) or Polynomial Unconstrained Binary Optimization (PUBO) variables).
C6. The method of any one of embodiments C1-C5, wherein the reduced number of qubits is 1 (e.g., 1=ceiling(log 2(k)), the one or more padding qubits include k−1 padding qubits, and the compiled quantum circuit includes k qubits.
C7. The method of any one of embodiments C1-C6, wherein the one or more measured qubits are one or more of the padding qubits of the compiled quantum circuit.
C8. The method of any one of embodiments C1-C7, wherein executing the compiled quantum circuit comprises using one or more decoders (316) to perform unitary mapping from the basis states of the reduced number of qubits padded with the one or more padding qubits to one-hot encoding basis states.
C9. The method of any one of embodiments C1-C8, wherein executing the compiled quantum circuit comprises using one or more ancilla qubits to take the mid-circuit measurements.
C10. The method of any one of embodiments C1-C9, wherein executing the compiled quantum circuit comprises using at least the one or more QPUs to determine parameters that optimize or approximately optimize an expectation value of a cost Hamiltonian.
C11. The method of any one of embodiments C1-C10, wherein executing the compiled quantum circuit comprises determining parameters by performing an optimization loop to optimize an expectation value of a cost Hamiltonian.
D1. A system (100 and/or 200) adapted to: compile an augmented quantum approximate optimization algorithm (QAOA) quantum circuit (304), wherein the augment quantum circuit includes a cost layer (308) that implements a unitary generated by a cost Hamiltonian, a mixer layer (310) that implements an XY mixer that connects all qubits in a one-hot encoding block to all other qubits in the encoding block via unitary gates, one or more encoders (312), mid-circuit measurements, and conditional resets; and execute the compiled quantum circuit (304), wherein the system, in executing the compiled quantum circuit, is adapted to: use the one or more encoders configured to perform unitary mapping of one-hot encoding basis states to basis states of a reduced number of qubits padded with one or more padding qubits in the zero computational basis state; use at least one or more quantum processing units (QPUs) (212 or 218) to take the mid-circuit measurements by measuring one or more qubits of the compiled quantum circuit in the computational basis state; determine that one or more mid-circuit measurement results indicate that one or more qubits of the compiled quantum circuit are in an invalid state; and, if the one or more mid-circuit measurement results are determined to indicate that the one or more qubits of the compiled quantum circuit are in the invalid state, reset the compiled quantum circuit without full execution of a variational loop.
E1. A computer program comprising instructions for adapting a system (100 and/or 200) to perform the method of any one of embodiments A1-A29 and C1-C11.
F1. A carrier containing the computer program of embodiment E1, wherein the carrier is one of an electronic signal, optical signal, radio signal, or compute readable storage medium.
G1. A system (100 and/or 200) comprising: processing circuitry (702); and a memory (742), said memory containing instructions (744) executable by said processing circuitry, whereby said apparatus is operative to perform the method of any one of the embodiments A1-A29 and C1-C11.
H1. A system (100 and/or 200) adapted to perform the method of any one of embodiments A1-A29 and C1-C11.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method comprising:
augmenting a quantum approximate optimization algorithm (QAOA) quantum circuit, wherein:
the quantum circuit includes a cost layer that implements a unitary generated by a cost Hamiltonian and a mixer layer that implements an XY mixer that connects all qubits in a one-hot encoding block to all other qubits in the encoding block via unitary gates;
augmenting the quantum circuit includes adding to the quantum circuit one or more encoders configured to perform unitary mapping of one-hot encoding basis states to basis states of a reduced number of qubits padded with one or more padding qubits in the zero computational basis state, mid-circuit measurements, conditional resets, and one or more decoders configured to perform unitary mapping from the basis states of the reduced number of qubits padded with the one or more padding qubits to one-hot encoding basis states;
the mid-circuit measurements are configured to cause one or more quantum processing units (QPUs) to measure one or more qubits of the augmented quantum circuit in the computational basis state; and
the one or more conditional resets are configured to reset the augmented quantum circuit without full execution of a variational loop if one or more mid-circuit measurement results indicate that one or more qubits of the augmented quantum circuit are in an invalid state.

2. The method of claim 1, wherein the mid-circuit measurements are configured to cause the one or more QPUs to measure in the computational basis state one or more qubits of the augmented quantum circuit expected to be in the zero computational basis state.

3. (canceled)

4. (canceled)

5. The method of claim 1, further comprising validating the quantum circuit and corresponding encodings.

6-12. (canceled)

13. The method of claim 1, wherein the one or more encoders comprise one or more unary-binary basis change operators, and the one or more decoders are one or more binary-unary basis change operators.

14. The method of claim 1, wherein the reduced number of qubits is 1, the one or more padding qubits include k−1 padding qubits, and the augmented quantum circuit includes k qubits.

15. The method of claim 1, wherein the mid-circuit measurements are configured to cause the one or more QPUs to measure one or more of the padding qubits of the augmented quantum circuit in the computational basis state.

16. The method of claim 1, wherein the augmented quantum circuit comprises one or more ancilla qubits configured to take the mid-circuit measurements.

17. The method of claim 1, further comprising compiling the augmented quantum circuit.

18. The method of claim 17, further comprising executing the compiled quantum circuit using at least the one or more QPUs.

19-28. (canceled)

29. A system adapted to:
augment a quantum approximate optimization algorithm (QAOA) quantum circuit, wherein:
the quantum circuit includes a cost layer that implements a unitary generated by a cost Hamiltonian and a mixer layer implements an XY mixer that connects all qubits in a one-hot encoding block to all other qubits in the encoding block via unitary gates;
augmenting the quantum circuit includes adding to the quantum circuit one or more encoders configured to perform unitary mapping of one-hot encoding basis states to basis states of a reduced number of qubits padded with one or more padding qubits in the zero computational basis state, mid-circuit measurements, conditional resets, and one or more decoders configured to perform unitary mapping from the basis states of the reduced number of qubits padded with the one or more padding qubits to one-hot encoding basis states;
the mid-circuit measurements are configured to cause one or more quantum processing units (QPUs) to measure one or more qubits of the augmented quantum circuit in the computational basis state; and
the one or more conditional resets are configured to reset the augmented quantum circuit without full execution of a variational loop if one or more mid-circuit measurement results indicate that one or more qubits of the augmented quantum circuit are in an invalid state.

30. A method comprising:
compiling an augmented quantum approximate optimization algorithm (QAOA) quantum circuit, wherein the augmented quantum circuit includes a cost layer that implements a unitary generated by a cost Hamiltonian, a mixer layer that implements an XY mixer that connects all qubits in a one-hot encoding block to all other qubits in the encoding block via unitary gates, one or more encoders, mid-circuit measurements, and conditional resets; and
executing the compiled quantum circuit, wherein executing the compiled quantum circuit comprises:
using the one or more encoders configured to perform unitary mapping of one-hot encoding basis states to basis states of a reduced number of qubits padded with one or more padding qubits in the zero computational basis state;
using at least one or more quantum processing units (QPUs) to take the mid-circuit measurements by measuring one or more qubits of the compiled quantum circuit in the computational basis state;
determining that one or more mid-circuit measurement results indicate that one or more qubits of the compiled quantum circuit are in an invalid state; and
if the one or more mid-circuit measurement results are determined to indicate that the one or more qubits of the compiled quantum circuit are in the invalid state, resetting the compiled quantum circuit without full execution of a variational loop.

31. The method of claim 30, wherein the mid-circuit measurements measure one or more qubits of the compiled quantum circuit expected to be in the zero computational basis state.

32. (canceled)

33. (canceled)

34. The method of claim 30, wherein executing the compiled quantum circuit comprises using an encoder to perform a one-hot encoding of variables.

35. The method of claim 30, wherein the reduced number of qubits is 1, the one or more padding qubits include k−1 padding qubits, and the compiled quantum circuit includes k qubits.

36. The method of claim 30, wherein the one or more measured qubits are one or more of the padding qubits of the compiled quantum circuit.

37. The method of claim 30, wherein executing the compiled quantum circuit comprises using one or more decoders to perform unitary mapping from the basis states of the reduced number of qubits padded with the one or more padding qubits to one-hot encoding basis states.

38. The method of claim 30, wherein executing the compiled quantum circuit comprises using one or more ancilla qubits to take the mid-circuit measurements.

39. (canceled)

40. A system adapted to:
compile an augmented quantum approximate optimization algorithm (QAOA) quantum circuit, wherein the augment quantum circuit includes a cost layer that implements a unitary generated by a cost Hamiltonian, a mixer layer that implements an XY mixer that connects all qubits in a one-hot encoding block to all other qubits in the encoding block via unitary gates, one or more encoders, mid-circuit measurements, and conditional resets; and
execute the compiled quantum circuit, wherein the system, in executing the compiled quantum circuit, is adapted to:
use the one or more encoders configured to perform unitary mapping of one-hot encoding basis states to basis states of a reduced number of qubits padded with one or more padding qubits in the zero computational basis state;
use at least one or more quantum processing units (QPUs) to take the mid-circuit measurements by measuring one or more qubits of the compiled quantum circuit in the computational basis state;
determine that one or more mid-circuit measurement results indicate that one or more qubits of the compiled quantum circuit are in an invalid state; and
if the one or more mid-circuit measurement results are determined to indicate that the one or more qubits of the compiled quantum circuit are in the invalid state, reset the compiled quantum circuit without full execution of a variational loop.

41. The system of claim 40, comprising:
processing circuitry; and
a memory containing instructions executable by said processing circuitry, whereby said system is operative to perform the compiling and the executing of the quantum circuit.

42. The system of claim 29, comprising:
processing circuitry; and
a memory containing instructions executable by said processing circuitry, whereby said system is operative to perform the augmenting.
